(19) United States
(12) Patent Application Publication
(10) Pub. No.: US 2002/0180344 A1
(43) Pub. Date: Dec. 5, 2002

(54) Flexible electronic device

(76) Inventor: Hans A. Lichtfuss, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/872,888

(22) Filed: May 31, 2001

(51) Int. Cl. H01J 1/62; H01J 63/04

(52) U.S. Cl. 313/498

(57) ABSTRACT

A flexible electronic device having a flexible display device operatively connected to a flexible circuit substrate, wherein the flexible circuit substrate outputs electric signals to the flexible display device causing the flexible display device to display data.

### TECHNICAL FIELD OF THE INVENTION

The present invention relates to flexible electronic devices and, more particularly, to a flexible electronic device having a flexible display device associated therewith.

### BACKGROUND OF THE INVENTION

Many electronic devices have a display device associated therewith for interfacing with a user. For example an electronic device, such as a personal data appliance (PDA) typically has a liquid crystal display (LCD) for displaying information to a user. Many electronic devices also have an input device, such as a touch screen, that is integral with the display device. The input device serves to provide a user with an input means for inputting information into the electronic device.

The display device generally tends to be the heaviest component of an electronic device. For example, an LCD display is typically formed from several substantially rigid and heavy substrates. The LCD display has an exterior substrate that is typically made of glass, which tends to be heavy relative to the other components within the electronic device. With a PDA having an LCD display, the display makes up a substantial portion of the PDA. Accordingly, the PDA may be relatively heavy due to the weight of the display device.

The display device also tends to be the most fragile component of an electronic device. As described above, an LCD display typically has a plurality of rigid substrates. Should one of the substrates become cracked or otherwise damaged, the LCD display and, thus, the electronic device will be rendered inoperable. Likewise, should the LCD display bend or otherwise experience excessive force, it will likely become damaged and the electronic device will be rendered inoperable. For example, if a PDA is dropped to the floor by a user, the weight of the device will cause a substantial force to be applied to the device upon impact with the floor. The force may damage the display device which will render the PDA inoperable.

### SUMMARY OF THE INVENTION

The present invention is directed toward an electronic device that may comprise a flexible display, a flexible circuit substrate, and a power source. The flexible display device may comprise a display device first surface and a display device second surface oppositely disposed the display device first surface. The display device first surface may comprise a viewable surface and the display device second surface may comprise at least one display device conductor.

The flexible circuit substrate may comprise a substrate first surface and a substrate second surface oppositely disposed the substrate first surface. The substrate first surface may comprise at least one substrate first conductor and the substrate second surface may comprise at least one substrate second conductor. The power source may comprise at least one power source conductor.

The display device second surface may be located adjacent the substrate first surface and the substrate second surface may be located adjacent the power source. The display device conductor may be operatively connected to the substrate first conductor and the substrate second conductor may be operatively connected to the power source conductor.

### BRIEF DESCRIPTION OF THE DRAWINGS

FIG. 1 is an exemplary top perspective view of a flexible electronic device of the present invention.

FIG. 2 is an exemplary side perspective cut away view of the flexible electronic device of FIG. 1.

FIG. 3 is view of the flexible electronic device of FIG. 1 undergoing deflection.

FIG. 4 is an exemplary side perspective view of the flexible electronic device of FIG. 2 with the addition of a pressure sensitive layer.

### DETAILED DESCRIPTION OF A PREFERRED EMBODIMENT

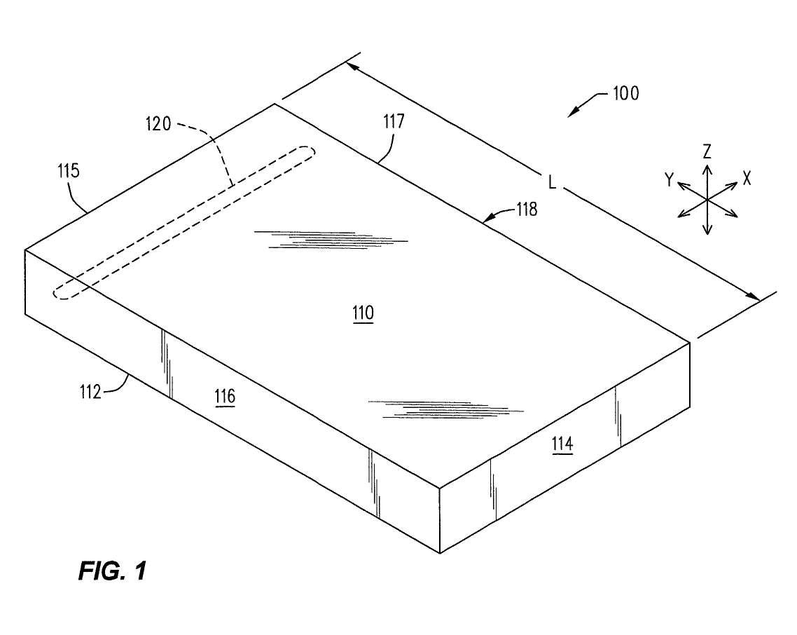

A non-limiting embodiment of a flexible electronic device 100 is illustrated in FIG. 1. In this embodiment, the electronic device 100 is a personal data appliance (PDA). It should be noted that the electronic components as described herein may be incorporated into devices other than PDAs, such as computers and viewing devices. One example of a flexible electronic device is disclosed in the U.S. patent application, Ser. No. ______ of Lichtfuss for FLEXIBLE ELECTRONIC VIEWING DEVICE concurrently filed with this application.

The electronic device 100 may have an upper portion 110, a lower portion 112, a front portion 114, a back portion 115, a first side portion 116, and a second side portion 117. The second side portion 117 may have a midpoint 118 located between the front portion 114 and the back portion 115. The midpoint 118 may be located on the top surface of the electronic device 100. A length L may extend between the front portion 114 and the back portion 115.

As will be described in greater detail below, the upper portion 110 may be adapted to display information in the form of text and graphics in a manner similar to a conventional PDA. The side portions, such as the first side portion 116 may be made of a flexible material, such as a polymer, that serves to seal the electronic device 100 and to maintain the flexibility of the electronic device 100.

For orientation purposes in describing the electronic device 100, reference is made to an x-direction X, a y-direction Y, and a z-direction Z that are all perpendicular to each other. The x-direction X and the y-direction Y are orthogonal directions on the upper portion 110 and the z-direction Z is normal to the upper portion 110.

The electronic device 100 may have an antenna 120 affixed therein. Like other components of the electronic device, the antenna 120 may be relatively flexible and may be made of a flexible conductive material, such as a flexible copper strip. As described in greater detail below, the antenna 120 may be adapted to transmit and receive radio frequency signals having a preselected frequency or within a preselected frequency band. The antenna 120 may serve to provide wireless communications between the electronic device 100 and a peripheral electronic device, such as a personal computer or a printer. Such wireless communications are well known in the art.

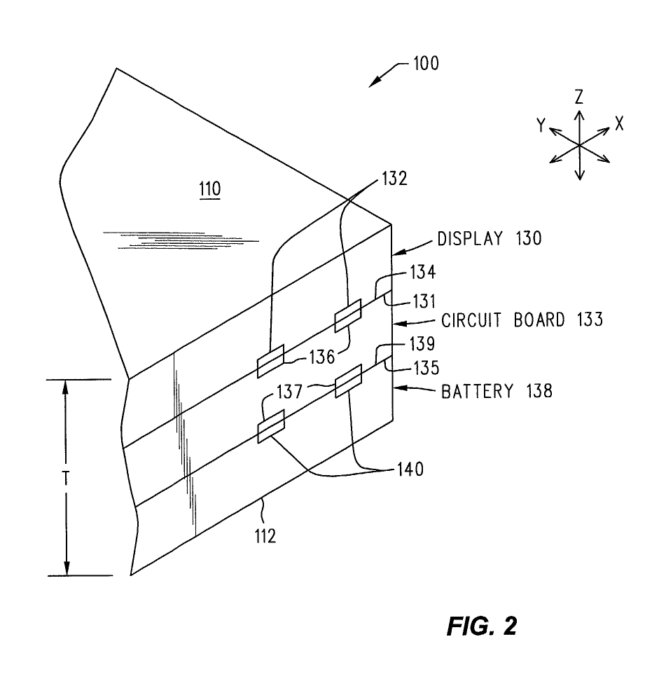

A partial, substantially enlarged, side perspective view of the electronic device 100 is shown in FIG. 2. The electronic device 100 may have a thickness T, extending between the upper portion 110 and the lower portion 112. The thickness T may, as a non-limiting example, be approximately two to five millimeters. It should be noted that the thickness T is dependent on the thickness of different components of the electronic device 100. Therefore, the thickness T may vary a great amount depending on the components used within the electronic device 100.

In the non-limiting example shown in FIG. 2, the electronic device 100 has three layers. A first layer 130 may be a display and is sometimes referred to herein as a display layer 130. One side surface of the display layer 130 may be the upper portion 110 of the electronic device 100. The display layer 130 also has an opposite side or surface that is referenced as the display lower surface 131. The display lower surface 131 may have a plurality of display conductors 132 associated therewith. The display conductors 132 may serve to operatively or otherwise electrically connect the display layer 130 to other components of the electronic device 100. As described in greater detail below, the display conductors 132 may serve to transmit data between the display layer 130 and other components of the electronic device 100. In the non-limiting embodiment of FIG. 2, the display conductors 132 are embedded within the display layer 130. It should be understood that other configurations of the display conductors 132 may be used herein. For example, the display conductors 132 may extend from the display lower surface 131 of the display layer 130 rather than being embedded into the display layer 130.

The display layer 130 may, as a non-limiting example, be a flexible liquid crystal display (LCD). The display layer 130 may have a plurality of plastic substrates and may use liquid crystal between the substrates to display information. As another non-limiting example, the display layer 130 may be an organic light-emitting device (OLED). Such flexible LCDs and OLEDs are known in the art. Accordingly, the display layer 130 described herein is flexible and light weight.

A second layer 133 may be operatively or otherwise mechanically and electrically connected to the display layer 130 adjacent the lower surface 131 of the display layer 130. The second layer 133 may be a circuit board and is sometimes referred to herein as the circuit board layer 133. The circuit board layer 133 may have a circuit board upper surface 134 and a circuit board lower surface 135. The circuit board upper surface 134 may have a plurality of upper circuit conductors 136 embedded therein. Likewise, the circuit board lower surface 135 may have a plurality of lower circuit conductors 137 embedded therein. The upper circuit conductors 136 and the lower circuit conductors 137 may be substantially similar to the display conductors 132 described above.

The circuit board upper surface 134 may be operatively connected to the display lower surface 131 of the display layer 130. For example, the display conductors 132 of the display layer 130 may electrically contact the upper circuit conductors 136 of the circuit board layer 133. An attachment mechanism, not shown, such as a flexible adhesive may physically attach the display layer 130 to the circuit board layer 133. As described below, the circuit board lower surface 135 of the circuit board layer 133 may be adjacent or otherwise in physical contact with a battery layer 138.

The circuit board layer 133 may be made of a flexible printed circuit material that is capable of having electronic components mounted thereto or imaged thereon. Flexible printed circuit boards are well known in the art. In order to maintain the flexibility of the electronic device 100, the circuit board layer 133 may have small surface mount components electrically and mechanically mounted thereto or integrally formed therein. In one non-limiting embodiment of the circuit board layer 133, the circuit board layer 133 is made of Mylar and has circuits imaged onto the Mylar surface. In addition, the circuit board layer 133 may have the upper circuit conductors 136 and the lower circuit conductors 137 formed therein.

The circuit board layer 133 and the display layer 130 may be mechanically and electrically connected together. The mechanical connection assures that the display conductors 132 on the display lower surface 131 and the upper circuit conductors 136 on the circuit board upper surface 134 are properly aligned to provide electrical contact and, thus, electronic data transfers therebetween. As described in greater detail below, the electronic data transfers provide for the upper portion 110 of the electronic device 100 to display images, such as text, graphics, or other data, similar to the text or graphics displayed on a conventional personal data appliance (PDA). The mechanical connection between the display layer 130 and the circuit board layer 133 provides for flexibility of the electronic device 100 while maintaining the electrical connection between the display layer 130 and the circuit board layer 133.

In one non-limiting embodiment of the electronic device 100 an anisotropic adhesive, not shown, that only conducts in the z-direction Z may be used to electrically and mechanically connect the display layer 130 to the circuit board layer 133. In this embodiment, the display conductors 132 on the display lower surface 131 are aligned with the upper circuit conductors 136 on the circuit board upper surface 134. The anisotropic adhesive will then conduct between the adjacent conductors of the display layer 130 and the circuit board layer 133. Because the anisotropic adhesive only conducts in the z-direction Z, it will not short out adjacent conductors on the same surface. For example, adjacent conductors on the circuit board upper surface 134 will not short through the anisotropic adhesive.

In one embodiment of the electronic device 100, the display layer 130 is substantially the same size and shape as the circuit board layer 133. Having the display layer 130 substantially the same size and shape as the circuit board layer 133 provides for some structural integrity for the electronic device 100, while assuring that the electronic device 100 remains flexible. Other layers of the electronic device 100, as described below, may also be substantially the same size and shape as the circuit board layer 133.

The electronic device 100 may also have a third layer 138 operatively or otherwise mechanically and electrically connected to the circuit board lower surface 135 of the circuit board layer 133. The third layer 138 is sometimes referred to herein as the battery layer 138. The battery layer 138 may have a battery upper surface 139 and a lower surface, which in the non-limiting embodiment described herein is the lower portion 112 of the electronic device 100. The battery upper surface 139 may have a plurality of battery conductors 140 that are aligned with the lower circuit conductors 137 on the circuit board lower surface 135. The battery conductors 140 serve to provide electric power to the circuit board layer 133 and the display layer 130. An anisotropic adhesive as describe above may serve to electrically and mechanically connect the battery upper surface 139 to the circuit board lower surface 135.

Like the other components of the electronic device 100, the battery layer 138 may also be flexible. The battery layer 138 may be a flexible battery or other flexible power source. In one embodiment, the battery layer 138 is a flexible substrate having a flexible battery associated therewith. In one non-limiting embodiment of the electronic device 100, the battery layer 138 and, thus, the battery associated therewith may be made of a lithium polymer. The battery layer 138 may be electrically connected to the circuit board layer 133 and the display layer 130 as was described above. In one embodiment of the electronic device 100, the battery layer 138 is rechargeable and has contacts located thereon for charging purposes.

Referring to FIGS. 1 and 2, the antenna 120 may be located within virtually any of the above-described layers of the electronic device 100. Alternatively, the antenna 120 may be located between any of the above-described layers of the electronic device 100. In one embodiment, an insulative adhesive is used to secure the antenna 120 between layers of the electronic device 100. The insulative adhesive prevents the antenna from conducting with or shorting out components within the electronic device 100. Alternatively, the antenna 120 may be attached to an exterior portion of the electronic device 100. The exterior mounting of the antenna 120 may be such that the antenna 120 is pivotally attached to the electronic device 100.

As described above, all the structural components of the electronic device 100 are flexible. Accordingly, the electronic device 100 as a whole is flexible. The flexibility of the electronic device 100 is dependent on the flexibility of the individual layers in addition to the adhesive or other mechanism used to attach the layers to each other. In one non-limiting embodiment, an adhesive that is pliable, such as a latex or a urethane based adhesive having a low durometer, is used to secure the layers to each other. This adhesive serves to maintain the flexibility and integrity of the electronic device 100.

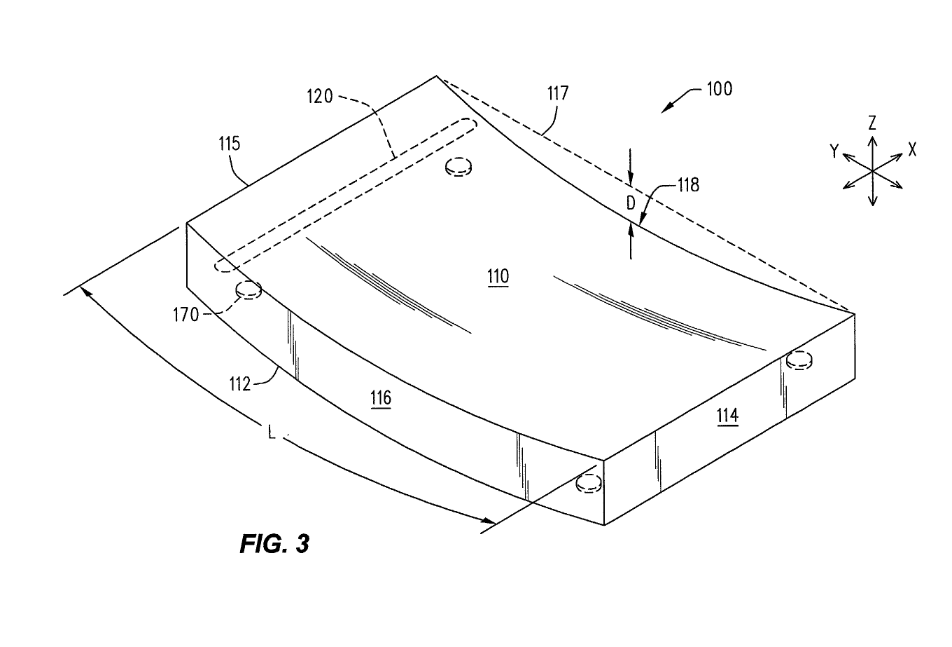

Referring to FIG. 3, in the preferred embodiment, the electronic device 100 is sufficiently flexible to deflect from the planar orientation to a deflected orientation with the midpoint 118 of the electronic device 100 deflected a deflection distance D. The deflection distance D is measured from a plane or line intersecting the top surface of the front portion 114 and the back portion 115 of the electronic device 100 and extending normal from the plane or line to the midpoint 118. As shown in FIGS. 1 and 3, the electronic device has a length L. Accordingly, the flexibility of the electronic device is proportional to the deflection distance D divided by the length L. In one embodiment of the electronic device 100, the electronic device is able to undergo a deflection distance D of at least about one centimeter, when the length L is about twelve centimeters. In other embodiments of the electronic device 100, the deflection distance D may be different. For example, the deflection distance D may be five centimeters over the length L of twelve centimeters. The electronic device 100 is able to return to its original state and continue to operate. It should be noted that the individual layers of the electronic device 100 must be able to flex or deflect as described above in order to allow the whole electronic device 100 flex or deflect. As used herein to described the electronic device 100 as a whole or the individual component layers therein, the term “flexible” means having the capacity to flex or deflect at least one centimeter over a twelve centimeter length or span as described in this paragraph.

Having described an embodiment of the electronic device 100, the operation of the electronic device 100 will now be described.

The electronic device 100 described above functions as a display device. In summary, the upper portion 110 of the electronic device 100 displays information pursuant to instructions from the circuit board layer 133. Both the display layer 130 and the circuit board layer 133 are powered by the battery layer 138. The antenna 120 provides for communications with an external electronic device, such as a computer, not shown, having a transmitter compatible with the antenna 120 and its associated receiver.

In one embodiment of the operation of the electronic device 100, data representative of information to be displayed by the electronic device 100 is transmitted via radio frequency signals from a peripheral electronic device to the electronic device 100. The antenna 120 within the electronic device 100 receives the radio frequency signals and transmits them to the circuit board layer 133. Electronics, not shown, on the circuit board layer 133 convert the radio signals to a data format that may be output to the display layer 130. The circuit board layer 133 outputs electronic signals representative of this data format to the display layer 130 via the above-described electrical connections between the circuit board layer 133 and the display layer 130. The data is then displayed on the upper portion 110 of the display layer 130.

It should be noted that the antenna 120 may also serve to transmit radio frequency signals to the above-described peripheral electronic device. The two-way communication of the antenna 120 and its associated electronics may provide for the electronic device 100 to notify the peripheral electronic device of the status of data transfers. For example, should the electronic device 100 encounter an error in receiving data, it may transmit a signal to the peripheral electronic device indicating that a transmission error occurred. Corrective action may then be taken.

The electronic device 100 described herein has many advantages over conventional electronic devices having integral display devices. In one non-limiting embodiment, the electronic device 100 is only a few millimeters thick and is much lighter than conventional electronic devices having integral display devices. Therefore, the electronic device 100 may be easily carried by a user because of its low weight. Furthermore, should the electronic device 100 be dropped, a minimal force will be exerted on the electronic device 100 because of its light weight and its ability to absorb shock through nondestructive deformation. Therefore, the electronic device 100 is not as likely to be damaged due to being dropped.

In addition, the flexibility of the electronic device 100 allows it to be stored in a compact location with a lower probability that it will be damaged. For example, the electronic device 100 may be placed in a briefcase where it is bent or otherwise mishandled. The flexibility of the electronic device 100 lowers the probability that the electronic device 100 will be damaged due to the bending and mishandling.

Having described an embodiment of the electronic device 100, other embodiments of the electronic device 100 will now be described.

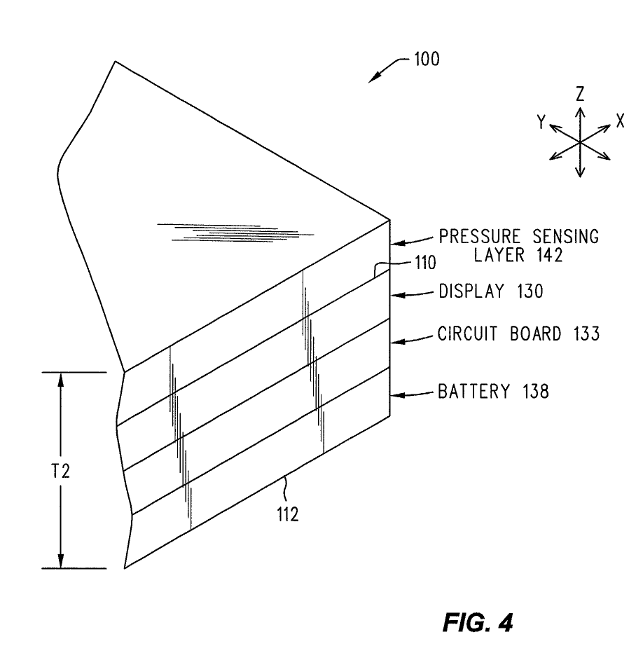

Referring to FIG. 4, one embodiment of the electronic device 100 has a pressure sensitive layer 142 attached to the top portion 110 of the display layer 130. The pressure sensing layer 142 is sometimes referred to as the touch screen 142. The touch screen 142 is substantially transparent and, thus, does not interfere with a user viewing the upper portion 110 of the display layer 130. The touch screen 142 may, as a non-limiting example, be a flexible four-wire pressure sensing device.

The touch screen 142 generates data when pressure is applied to it. For example, a stylus may be pressed against the touch screen 142, which causes the touch screen 142 to generate data. The data generated by the touch screen 142 is indicative of the location in the x-direction X and the y-direction Y from where the application of pressure occurred. As described below, the touch screen 142 enables a user to input information into the electronic device 100. In one embodiment of the electronic device 100, a compression force generated by flexing the electronic device 100 will not be enough for the touch screen 142 to generate data. Accordingly, when the electronic device 100 is flexed, the touch screen 142 will not generate data.

The use of the touch screen 142 enables the electronic device 100 to function similar to a conventional PDA. For example, information relating to a choice of preselected inputs may be displayed by the display layer 130 at preselected locations. A user may input the data to the electronic device 100 by applying pressure to the touch screen 142 at the appropriate location of the touch screen 142 corresponding to a preselected input. The electronic device 100 correlates the data generated by the touch screen 142 to the preselected input.

In another embodiment of the electronic device 100, the battery or power source is not a layer as was described above and as is shown in FIG. 2. Referring again to FIG. 3, the battery may be a conventional battery or batteries 170 located within the electronic device 100. The batteries 170 may, as an example, be relatively small and may be located between or imbedded within the above-described layers of the electronic device 100. In the embodiment of the electronic device 100 shown in FIG. 3, several batteries 170 are located therein and are located adjacent the side portions 114, 115, 116, 117 of the electronic device 100. If the batteries 170 are relatively small, they may be relatively rigid and the electronic device 100 will remain flexible. It should be noted that the electronic device 100 may have more or less than the four batteries 170 shown in FIG. 3.

The battery whether a discrete device or a layer, as described above, may be rechargeable. Recharging terminals or other contacts for recharging purposes may be located on an exterior surface of the battery layer 138 or an exterior surface of another layer of the electronic device 100. Recharging may be accomplished by setting the electronic device 100 against a charging device so that the recharging terminals contact charging terminals of the charging device.

In another embodiment of the electronic device 100, transmission means other than radio frequency are used to communicate with a peripheral device. For example, the electronic device 100 may include an optical receiver or transceiver that communicates with a peripheral electronic device in a manner similar to the antenna 120. The optical devices may be so small that they do not impact the flexibility of the electronic device 100.

In another embodiment of the electronic device 100, all the layers of the electronic device 100 have conductors located in the same position with respect to each other. For example, the conductors may be located proximate the back portion 115 of the electronic device 100. The layers of the electronic device 100 may be fixedly connected together at this point, similar to the manner in which a pad of paper is bound at one end. This connection of the layers assures that the conductors within the layers will contact each other as the electronic device 100 is flexed. The remaining portion of the layers may be adhered or otherwise fastened together so as to slip. Because no electrical connections exist in the above-described remaining portion of the layers, the slip may be significant and will not damage the electrical connections between the layers.

In another embodiment of the electronic device 100, the electronic device 100 has external electric contacts for use in a docking station or the like. The electronic device 100 may be placed within the docking station, which allows the electronic device 100 to communicate with peripheral devices and recharge its battery via the electric contacts.

What is claimed is:

1. An electronic device comprising:
a flexible display device comprising a display device first surface and a display device second surface oppositely disposed said display device first surface, said display device second surface comprising at least one display device conductor; and
a flexible circuit substrate comprising a substrate first surface and a substrate second surface oppositely disposed said substrate first surface, said substrate first surface comprising at least one substrate first conductor;
said display device second surface being located adjacent said substrate first surface and said substrate second surface being located adjacent said power source; and
said at least one display device conductor being operatively connected to said at least one substrate first conductor.

2. The device of claim 1, and further comprising a flexible pressure sensing layer operatively connected to said display device first surface.

3. The device of claim 1, and further comprising a power source.

4. The device of claim 3, wherein said power source is flexible.

5. The device of claim 3, wherein said power source comprises a power source first surface, a power source second surface oppositely disposed relative said power source first surface, and a power source conductor located on said power source first surface; and wherein said substrate second surface comprises a substrate second conductor; said power source first surface being located adjacent said substrate second surface; and said power source conductor being operatively connected to said substrate second conductor.

6. The device of claim 3, wherein said power source is rechargeable.

7. The device of claim 3, wherein the shape of said power source is substantially similar to the shape of said flexible circuit substrate.

8. The device of claim 3, wherein said power source is a battery comprising lithium polymer.

9. The device of claim 1, wherein the shape of said display device is substantially similar to the shape of said flexible circuit substrate.

10. The device of claim 1, wherein said display device comprises a polymer and liquid crystal.

11. The device of claim 1, wherein said display device is an organic light-emitting device.

12. The device of claim 1, wherein the thickness of said display device is about one millimeter.

13. The device of claim 1, and further comprising an antenna operatively connected to said flexible circuit substrate.

14. The device of claim 13, wherein said antenna is located adjacent said flexible circuit substrate.

15. The device of claim 1, wherein the thickness of said flexible circuit substrate is about one millimeter.

16. The device of claim 1, and further comprising an anisotropic adhesive electrically and mechanically connecting said display device to said flexible circuit substrate.

17. The device of claim 1, wherein said flexible circuit substrate comprises Mylar.

18. The device of claim 1, and further comprising an optical receiver operatively connected to said flexible circuit substrate.

19. The device of claim 1, and further comprising an optical transmitter operatively connected to said flexible circuit substrate.

20. An electronic device comprising:
a flexible display device comprising a display device first surface and a display device second surface oppositely disposed said display device first surface, said display device first surface comprising a viewable surface, said display device second surface comprising at least one display device conductor;
a flexible circuit substrate comprising a substrate first surface and a substrate second surface oppositely disposed said substrate first surface, said substrate first surface comprising at least one substrate first conductor, and said substrate second surface comprising at least one substrate second conductor; and
a flexible power source comprising a power source first side and a power source second side oppositely disposed said power source first side, said power source first side comprising at least one first power source conductor;
said display device second surface being adhered to said substrate first surface and said substrate second surface being adhered to said power source first surface; and
said at least one display device conductor being electrically connected to said at least one substrate first conductor and said at least one substrate second conductor being electrically connected to said at least one power source first conductor.

21. A flexible display device comprising:
a flexible display means for displaying data;
a flexible circuit means for transmitting data to said display means, said flexible circuit means being located adjacent said flexible display means; and
a flexible power source means for supplying power to said flexible circuit means.
